(19) United States
(12) Patent Application Publication
(10) Pub. No.: US 2015/0081386 A1
(43) Pub. Date: Mar. 19, 2015

(54) MEDIATION DEVICE, MEDIATION METHOD, AND RECORDING MEDIUM

(71) Applicant: YAHOO JAPAN CORPORATION, Tokyo (JP)

(72) Inventor: Nobuyuki SHIMIZU, Tokyo (JP)

(21) Appl. No.: 14/325,826

(22) Filed: Jul. 8, 2014

(30) Foreign Application Priority Data
Sep. 18, 2013 (JP) 2013-193301

(51) Int. Cl. G06Q 30/02

(52) U.S. Cl. CPC G06Q 30/0203
USPC 705/7.32

(57) ABSTRACT

A mediation device according to the present application includes a task reception unit, a deliverable reception unit, a calculation unit, and a measures unit. The task reception unit receives work including one or more dummy questions from an order terminal used by an orderer. The deliverable reception unit receives deliverables of the work including answers to the dummy question from a plurality of acceptor terminals used by a plurality of acceptors. The calculation unit calculates some answer state of the dummy question included in the deliverables received by a second reception unit. The measures unit executes predetermined measures according to the answer state calculated by a calculation unit.

### CROSS-REFERENCE TO RELATED APPLICATION(S)

The present application claims priority to and incorporates by reference the entire contents of Japanese Patent Application No. 2013-193301 filed in Japan on Sep. 18, 2013.

### BACKGROUND OF THE INVENTION

1. Field of the Invention

The present invention relates to a mediation device, a mediation method, and a recording medium.

2. Description of the Related Art

In recent years, as one embodiment of outsourcing forms, crowdsourcing in which work is outsourced to a number of unspecified persons is known. As a technology related to the crowdsourcing, a technology of ordering business in a competition method is known. For example, in such a technology, an orderer notifies a request of business to acceptors, and business is directly proposed by the acceptors, so that the orderer selects the most favorable proposal.

Patent Literature 1: Japanese Laid-open Patent Publication No. 2010-092451

Patent Literature 2: Japanese Laid-open Patent Publication No 2004-295607

However, the above conventional technology cannot always provide an appealing outsourcing form for the orderer and the acceptors. For example, the orderer determines acceptance/unacceptance of delivery of a deliverable by the acceptor, and thus when unacceptance of delivery determined by the orderer is arbitrary, the acceptor's interest may be harmed. Therefore, the above conventional technology cannot always provide an appealing outsourcing form for the orderer and the acceptors.

According to one aspect of embodiments, an effect to provide an appealing outsourcing form for the orderer and the acceptors.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an example of mediation processing by a mediation system according to an embodiment;

FIG. 2 is a diagram illustrating a configuration example of a mediation device according to an embodiment;

FIG. 3 is a diagram illustrating an example of a task information storage unit according to an embodiment;

FIG. 4 is a sequence illustrating a mediation processing procedure by a mediation device;

FIG. 5 is an explanatory diagram illustrating an example of mediation processing by a mediation device according to a modification;

FIG. 6 is an explanatory diagram illustrating an example of mediation processing by a mediation device according to a modification;

FIG. 7 is an explanatory diagram illustrating an example of mediation processing by a mediation device according to a modification;

FIG. 8 is an explanatory diagram illustrating an example of processing according to an incorrect answer rate according to a modification;

FIG. 9 is an explanatory diagram illustrating an example of mediation processing by a mediation device according to a modification; and

FIG. 10 is a hardware configuration diagram illustrating an example of a computer that realizes a function of a mediation device.

### DETAILED DESCRIPTION OF THE PREFERRED EMBODIMENTS

Hereinafter, embodiments for implementing a mediation device, a mediation method, and a recording medium according to the present application (hereinafter, referred to as “embodiments”) will be described in detail with reference to the drawings. Note that the mediation device, the mediation method, and the recording medium according to the present application are not limited by these embodiments. Further, the same portions are denoted with the same reference sign in the following embodiment, and duplicated description is omitted.

1. Mediation Processing

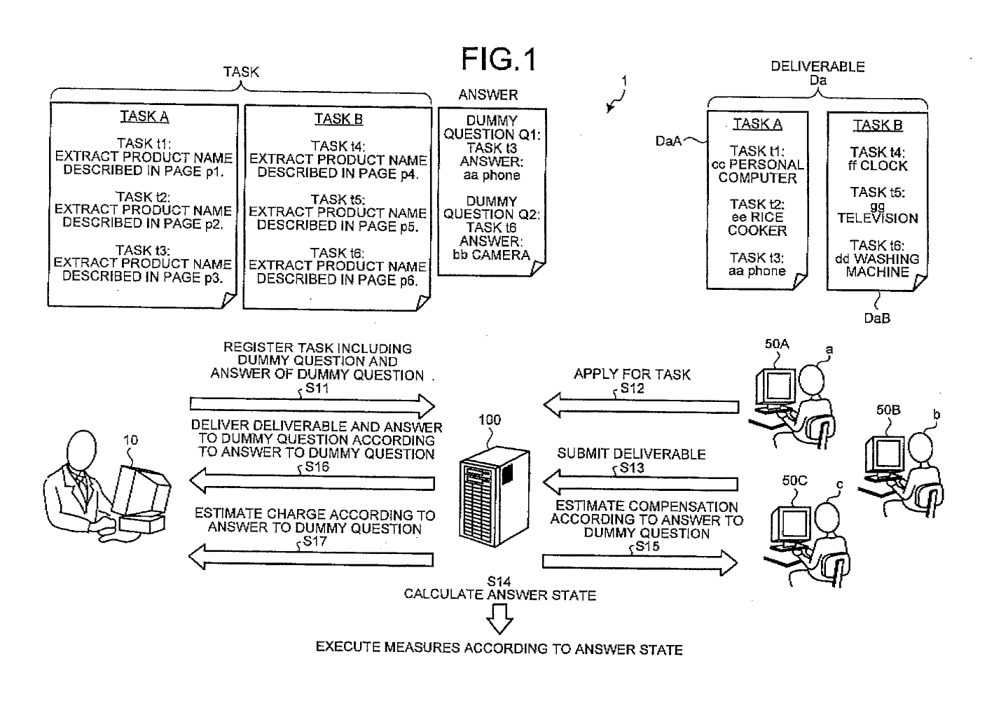

First, an example of mediation processing according to an embodiment will be described with reference to FIG. 1. FIG. 1 is an explanatory diagram illustrating an example of mediation processing by a mediation system 1 according to an embodiment. In the example of FIG. 1, mediation processing of mediating order and acceptance of work is performed by a mediation device 100 managed by an intermediary.

As illustrated in FIG. 1, the mediation system 1 includes an order terminal 10, acceptor terminals 50A to 50C, and the mediation device 100. The order terminal 10, the acceptor terminals 50A to 50C, and the mediation device 100 are communicatively connected each other through a network by a wireless means.

The order terminal 10 and the acceptor terminals 50A to 50C are information processing devices, such as a personal computer (PC), a tablet type terminal, a smart phone, or a personal digital assistance (PDA). The mediation device 100 is a sever device that executes mediation processing of mediating outsourcing of a task between the order terminal 10 and the acceptor terminal 50.

Here, description will be given regarding the mediation processing, assuming a case in which an owner that is the orderer outsources work to a large number of unspecified agents that are the acceptors through the mediation device 100. Here, assume that the work outsourced to the agents is a task to extract a product name described on a web page specified by the owner, as illustrated in FIG. 1. Such a web page introduces a product in an auction site. As illustrated in FIG. 1, a task t1 included in a task A is work that assigns extraction of a product name described in a page p1. Note that the task includes one or more dummy questions used for determining quality of a deliverable of the task. For example, the task A includes a task t3 as the dummy question.

In the example of FIG. 1, first, the owner operates the order terminal 10 to transmit the task including the dummy question and an answer of the dummy question to the mediation device 100. Accordingly, the owner registers the task and the answer of the dummy question to the mediation device 100 (step S11). Note that, here, the task is formed of the task A and a task B, as illustrated in FIG. 1. Further, the dummy questions are the task t3 (dummy question Q1) included in the task A, and a task t6 (dummy question Q2) included in the task B, as illustrated in FIG. 1. Further, the answer of the dummy question Q1 is “aa phone”. The answer of the dummy question. Q2 is “bb camera”.

The mediation device 100 then receives applications for the task from agents a to c. To be specific, the agents operate the acceptor terminals 50A to 50C to transmit acceptance requests to the mediation device 100. Accordingly, the agents a to c apply for the task registered in the mediation device 100 (step S12).

Following that, when the applications for the task have been accepted by the mediation device 100, the agents a to c create deliverables of the task. In the example of FIG. 1, the deliverables of the task are data in which an answer to each task has been input. For example, as illustrated in FIG. 1, a deliverable DaA of the task A created by the agent a is data in which a “cc personal computer” is input as the product name described in the page p1 assigned in the task t1. The agent a then operates the acceptor terminal 50A to transmit any deliverable of the deliverables Da to the mediation device 100. Similarly, other agents b to c operate the acceptor terminals 50B to 50C to transmit the deliverables to the mediation device 100. Accordingly, the agents a to c submit the deliverables to the mediation device 100 (step S13). Note that, in FIG. 1, an example in which three agents a to c respectively submit the deliverables has been described. However, in reality, a large number of unspecified agents submit the deliverables, respectively. Further, the deliverables created by the agents are not the same and are different. That is, the deliverables created by the agents may have different answers to the task that is the dummy question.

Then, the mediation device 100 grades the dummy questions included in the deliverables of the task submitted by the acceptor terminals 50A to 50C, using the registered answer of the dummy question. To be specific, the mediation device 100 grades whether the registered answer of the dummy question and the answer to the dummy question included in the deliverable are matched, for each dummy question. Here, when the answers are matched, the mediation device 100 grades the answer is a correct answer. Meanwhile, when the answers are not matched, the mediation device 100 grades the answer is an incorrect answer.

In the example of FIG. 1, “aa phone” that is the answer to the task 3 included in the deliverable DaA is matched with the answer “aa phone” of the dummy question Q1. Therefore, the mediation device 100 grades the answer is a correct answer. Further, “dd washing machine” that is the answer to the task 6 included in the deliverable DaB is not matched with the answer “bb camera” of the dummy question Q2. Therefore, the mediation device 100 grades the answer is an incorrect answer. Accordingly, the mediation device 100 grades correctness/incorrectness of the answers to the dummy question Q1 and the dummy question Q2 included in the deliverable Da. Similarly, the mediation device 100 grades the correctness/incorrectness of the answers to the dummy question Q1 and the dummy question Q2 included in the deliverables submitted by the agents b to c.

Accordingly, the mediation device 100 calculates some answer state of one or more dummy questions for each dummy question (step S14). To be specific, the mediation device 100 calculates ratio of incorrect answer to the dummy question for each dummy question as the answer state of the dummy question. For example, assume a total of 100 deliverables have been submitted by 100 agents to the mediation device 100. Further, assume that 20 out of the 100 deliverables have made incorrect answers to the dummy question. In this case, the mediation device 100 calculates the incorrect answer rate of the dummy question to be 20%.

Following that, the mediation device 100 executes predetermined measures for the orderer according to the calculated answer state of the dummy question. To be specific, when the incorrect answer rate of the dummy question is a predetermined threshold or more, the mediation device 100 stops display of the task including the dummy question, and transmits, to the order terminal 10, notification that prompts the owner to change the dummy question. For example, assume that the predetermined threshold of the incorrect answer rate is set to 25%. Further, assume that the incorrect answer rate of the dummy question Q1 is 20%. Further, assume that the incorrect answer rate of the dummy question Q2 is 25%. In this case, the incorrect answer rate of the dummy question Q2 is the predetermined threshold or more, and thus the mediation device 100 stops display of the task B including the dummy question Q2, and transmits, to the order terminal 10, notification that prompts the owner to change the dummy question Q2. Note that the incorrect answer rate of the dummy question Q1 is less than the predetermined threshold. Therefore, the mediation device 100 does not stop display of the task A that includes the dummy question Q1 nor transmit notification that prompts the owner to change the dummy question Q1.

Accordingly, when the incorrect answer rate of the dummy question is a predetermined threshold or more, the mediation device 100 executes predetermined measures for the orderer. Therefore, the mediation device 100 can cause the owner to create a high-quality dummy question. Note that the incorrect answer rate of the dummy question is calculated by the mediation device 100 when the dummy question is answered predetermined number of times or more. This is because, when the number of answers to the dummy question is not sufficient, reliability of the quality of the dummy question indicated by the calculated incorrect answer rate can be considered low.

The mediation device 100 then estimates compensation to be paid to the agent according to the answer state of the dummy question (step S15). For example, when the answer to the dummy question is a correct answer, the mediation device 100 estimates compensation for the deliverable of the task including the dummy question as the compensation to be paid to the agent. In the example of FIG. 1, since the deliverable DaA has made the correct answer to the dummy question Q1, the mediation device 100 estimates compensation for the deliverable DaA as the compensation to be paid to the agent. Accordingly, the intermediary pays the estimated compensation to the agent.

Meanwhile, when the answer to the dummy question is an incorrect answer, the mediation device 100 estimates that compensation for the deliverable of the task including the dummy question is 0. In the example of FIG. 1, because the deliverable DaB has made the incorrect answer to the dummy question Q2, the mediation device 100 estimates that the compensation for the deliverable DaB is 0. In this way, when the answer to the dummy question is an incorrect answer, the intermediary does not pay the compensation to the agents. Therefore, an incentive to create a high-quality deliverable can be provided to the agents.

Further, the mediation device 100 transmits the deliverable to the owner according to the answer state of the dummy question. Accordingly, the mediation device 100 delivers the deliverable to the owner (step S16). For example, when the answer to the dummy question is a correct answer, the mediation device 100 transmits the deliverable including the answer to the dummy question to the order terminal 10. In the example of FIG. 1, because the deliverable DaA has made the correct answer to the dummy question Q1, the mediation device 100 transmits the deliverable DaA of the task A and the answer to the dummy question Q1 to the order terminal 10.

Meanwhile, when the answer to the dummy question is an incorrect answer, the mediation device 100 delivers only the answer to the dummy question of the deliverable to the owner. In the example of FIG. 1, since the deliverable DaB has made the incorrect answer to the dummy question Q2, the mediation device 100 transmits only the answer to the dummy question Q2 of the deliverable DaB of the task B to the order terminal 10. As described above, when the answer to the dummy question is an incorrect answer, the mediation device 100 does not deliver the deliverable to the owner. Therefore, an incentive to decrease a low-quality dummy question can be provided to the owner.

Further, the mediation device 100 estimates a charge to be billed to the owner according to the answer to the dummy question (step S17). For example, when the answer to the dummy question is a correct answer, the mediation device 100 estimates a total amount of brokerage to be received by the intermediary who manages the mediation device 100 and compensation to be received by the agent, as the charge to be billed to the owner. In the example of FIG. 1, since the deliverable DaA has made the correct answer to the dummy question Q1, the mediation device 100 estimates the total amount of the brokerage and the compensation as the charge to be billed to the owner.

Meanwhile, when the answer to the dummy question is an incorrect answer, the mediation device 100 deducts the compensation and estimates the brokerage as the charge to be billed to the owner. In the example of FIG. 1, since the deliverable DaB has made the incorrect answer to the dummy question Q2, the mediation device 100 estimates only the brokerage as the charge to be billed to the owner. As described above, when the answer to the dummy question is an incorrect answer, the intermediary does not charge the owner for the compensation to be received by the agent. Therefore, the interest of the owner can be protected.

As described above, the mediation device 100 according to an embodiment executes predetermined measures for the orderer when the incorrect answer rate of the dummy question is a predetermined threshold or more. Therefore, the mediation device 100 can cause the owner to create a high-quality dummy question. Accordingly, the mediation device 100 can protect the interests of the owner and of the agents, and thus can provide an appealing outsourcing form to the owner and the agents.

Note that, in FIG. 1, an example in which the mediation system 1 includes one order terminal 10, three acceptor terminals 50A to 50C, and one mediation device 100 has been exemplarily illustrated. However, the mediation system 1 may include a plurality of order terminals 10, a plurality of acceptor terminals 50A to 50C, not just three, and a plurality of mediation devices 100. Further, hereinafter, when the devices of the acceptor terminals 50A to 50C are collectively called without being separated, the devices may be described as “acceptor terminal 50”.

2. Configuration of Mediation Device

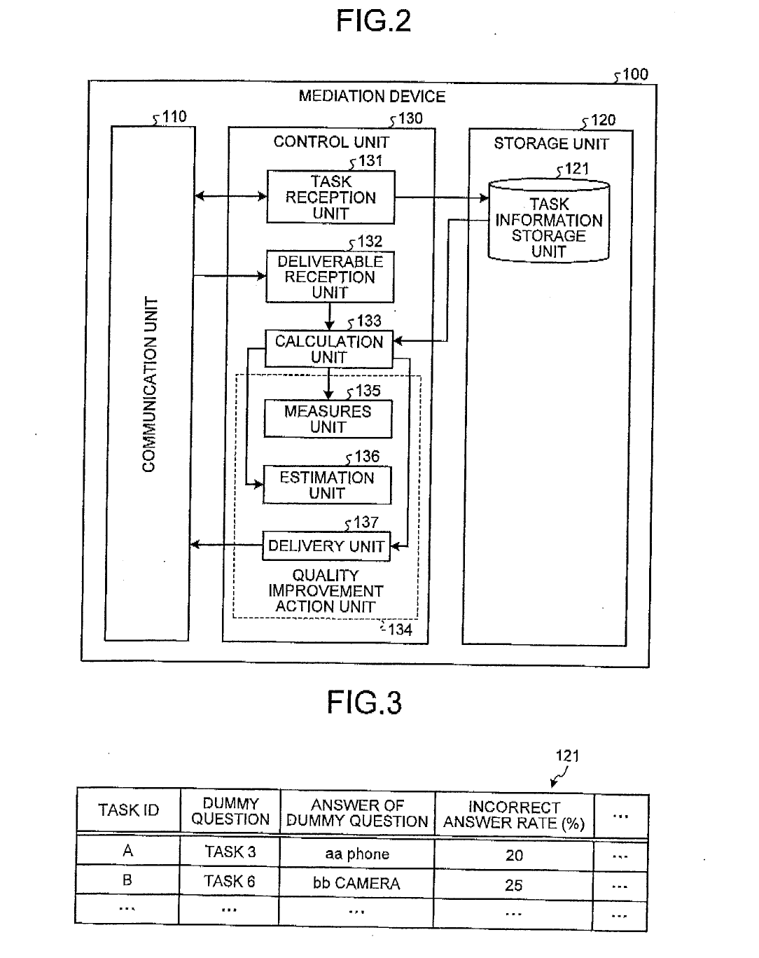

Next, a configuration of the mediation device 100 according to an embodiment will be described with reference to FIG. 2. FIG. 2 is a diagram illustrating a configuration example of the mediation device 100 according to an embodiment. As illustrated in FIG. 2, the mediation device 100 includes a communication unit 110, a storage unit 120, and a control unit 130. Note that the mediation device 100 may include an input unit (for example, a keyboard, a mouse, or the like) that receives various operations from an administrator or the like who uses the mediation device 100, and a display unit (for example, a liquid crystal display, or the like) for displaying various types of information.

Communication Unit 110

The communication unit 110 is realized by a NIC, and the like, for example. The communication unit 110 is connected with a network by a wired or wireless means, and performs transmission/reception of information to/from the order terminal 10 and the acceptor terminal 50 through the network.

Storage Unit 120

The storage unit 120 is realized by a random access memory (RAM), a semiconductor memory device such as a flash memory, or a storage device such as a hard disk or an optical disk. The storage unit 120 includes a task information storage unit 121.

Task Information Storage Unit 121

The task information storage unit 121 stores information related to a task. To be specific, the task information storage unit 121 stores information related to one or more dummy questions included in a task for each task. Here, FIG. 3 illustrates an example of the task information storage unit 121 according to an embodiment. As illustrated in FIG. 3, the task information storage unit 121 includes a “task ID”, a “dummy question”, an “answer of a dummy question” and an “incorrect answer rate”.

The “task ID” indicates identification information for identifying a task. The “dummy question” indicates a dummy question included in the task identified by the task ID. For example, among tasks, a task having a clear answer for the owner is set to the “dummy question”. The “answer of a dummy question” indicates a correct answer corresponding to the dummy question. The “incorrect answer rate” indicates ratio of incorrect answer for the dummy question by percentage. To be specific, the “incorrect answer rate” is calculated by dividing of the number of incorrect answers of the dummy question included in deliverables by the number of answers of the dummy question, and multiplying the quotient by 100, when the dummy question is answered a predetermined number of times or more.

That is, FIG. 3 illustrates an example in which the dummy question of the task A corresponding to the task ID “A” is the task 3. Further, the example illustrates the answer to the dummy question of the task A corresponding to the task ID “A” is “aa phone”. Further, the example illustrates the incorrect answer rate of the dummy question of the task A corresponding to the task ID “A” is “20”.

Control Unit 130

The control unit 130 is realized such that the various programs (corresponding to an example of mediation program) stored in the storage device inside the mediation device 100 are executed by a central processing unit (CPU) or a micro processing unit (MPU) using the RAM as a work area. Further, the control unit 130 is realized by an integrated circuit, such as an application specific integrated circuit (ASIC) or a field programmable gate array (FPGA).

The control unit 130 includes, as illustrated in FIG. 2, a task reception unit 131, a deliverable reception unit 132, a calculation unit 133, and a quality improvement action unit 134, and realizes or executes a function and an operation of information processing described below. Note that the internal configuration of the control unit 130 is not limited to the configuration illustrated in FIG. 2, and another configuration may be employed as long as the configuration performs mediation processing described below. Further, the connection relationship among the processing units included in the control unit 130 is not limited to the relationship illustrated in FIG. 2, and another connection relationship may be employed.

Task Reception Unit 131

The task reception unit 131 receives information related to a task from the order terminal 10. To be specific, the task reception unit 131 receives a task including a dummy question and an answer of the dummy question transmitted from the order terminal 10. The task reception unit 131 then stores the received task and answer to the dummy question in the task information storage unit 121. Further, the task reception unit 131 transmits the task stored in the task information storage unit 121 to the acceptor terminal 50 used by the agent whose application for the task has been received.

Deliverable Reception Unit 132

The deliverable reception unit 132 receives the deliverable of the task from the acceptor terminal 50. To be specific, the deliverable reception unit 132 receives the deliverable of the task including an answer to the dummy question transmitted from the acceptor terminal 50.

Calculation Unit 133

The calculation unit 133 calculates the answer state of the dummy question. To be specific, the calculation unit 133 calculates, for each dummy question, the answer state of the dummy question included in the deliverable received by the deliverable reception unit 132. For example, the calculation unit 133 grades whether the answer to the dummy question included in the deliverable and the answer of the dummy question stored in the task infoLmation storage unit 121 are matched. Accordingly, the calculation unit 133 calculates the answer state of the dummy question.

Further, the calculation unit 133 calculates, for each dummy question, the incorrect answer rate of the dummy question as the answer state of the dummy question. To be specific, the calculation unit 133 calculates the incorrect answer rate of the dummy question by dividing of the number of incorrect answers of the dummy question by the number of answers, and multiplying the quotient by 100, when the dummy question is answered a predetermined number of time or more. For example, when 20 out of the total of 100 deliverables submitted from the agents have made an incorrect answer to the dummy question, for example, the calculation unit 133 calculates the incorrect answer rate of the dummy question to be 20%.

Quality Improvement Action Unit 134

The quality improvement action unit 134 executes, for the owner or the agent, measures to improve the quality of the dummy question or the deliverable. To be specific, the quality improvement action unit 134 executes an action to improve the quality of the dummy question and the deliverable by a measures unit 135, an estimation unit 136, and a delivery unit 137.

Measures Unit 135

The measures unit 135 executes predetermined measures for the owner. To be specific, the measures unit 135 executes predetermined measures and actions for the owner according to the answer state of the dummy question. For example, when the incorrect answer rate of the dummy question calculated by the calculation unit 133 is a predetermined threshold or more, the measures unit 135 stops display of the task including the dummy question, and transmits notification that prompts the owner to change the dummy question to the order terminal 10. This is because, when the incorrect answer rate of the dummy question is higher than a predetermined threshold, the quality of the dummy question can be considered poor. Accordingly, the measures unit 135 can cause the owner to create a high-quality dummy question.

This point will be described using the example of FIG. 3. Here, assume that the predetermined threshold of the incorrect answer rate of the dummy question is 25%. As illustrated in FIG. 3, in the case of the task A with the incorrect answer rate of 20%, the incorrect answer rate is less than the predetermined threshold of 25%, and thus the measures unit 135 does not execute the predetermined measures for the owner. Meanwhile, in the case of the task B with the incorrect answer rate of 25%, the incorrect answer rate is the predetermined threshold of 25% or more, and thus the measures unit 135 stops display of the task B, and transmits notification that prompts the owner to change the dummy question of the task 3 included in the task B.

Estimation Unit 136

The estimation unit 136 estimates compensation to be paid to the agent and a charge to be billed to the owner. To be specific, the estimation unit 136 estimates the compensation to be paid to the agent according, to the answer to the dummy question. For example, when the answer to the dummy question is a correct answer, the estimation unit 136 estimates compensation for the deliverable of the task including the dummy question as the compensation to be paid to the agent. Meanwhile, when the answer to the dummy question is an incorrect answer, the estimation unit 136 estimates that compensation for the deliverable of the task including the dummy question is 0. This is because the deliverable having an incorrect answer to the dummy question can be considered to have low quality. Accordingly, the estimation unit 136 can cause the agent to create a high-quality deliverable.

Further, the estimation unit 136 estimates a charge to be billed to the owner according to the answer to the dummy question. For example, when the answer to the dummy question is a correct answer, the estimation unit 136 estimates a total amount of brokerage to be received by the intermediary who manages the mediation device 100 and compensation to be received by the agent as the charge to be billed to the owner. This is because the compensation is paid for the deliverable that can be considered to have high quality because the answer to the dummy question is a correct answer. Meanwhile, when the answer to the dummy question is an incorrect answer, the estimation unit. 136 estimates the brokerage without including the compensation to be received by the agent as the charge to be billed to the owner. This is because the compensation is not paid to the agent with respect to the deliverable that can be considered to have low quality because the answer to the dummy question is an incorrect answer. As described above, when the answer to the dummy question is an incorrect answer, the estimation unit 136 does not pay the compensation to the agent, and thus can cause the agent to create a high-quality deliverable. Further, the intermediary can recognize the amount of the charge to be billed to the owner and the compensation to be paid to the agent. Note that the estimation unit 136 may estimate the charge without counting the brokerage.

Delivery Unit 137

The delivery unit 137 delivers the deliverable and the answer to the dummy question to the owner. To be specific, the delivery unit 137 transmits the deliverable and the answer to the dummy question to the order terminal 10 according to the answer to the dummy question. For example, when the answer to the dummy question is a correct answer, the delivery unit 137 transmits the deliverables including the answer to the dummy question to the order terminal 10. Meanwhile, when the answer to the dummy question is an incorrect answer, the delivery unit 137 transmits only the answer to the dummy question of the deliverable to the order terminal 10. Accordingly, the delivery unit 137 can cause the owner to create a high-quality dummy question.

3. Procedure of Mediation Processing

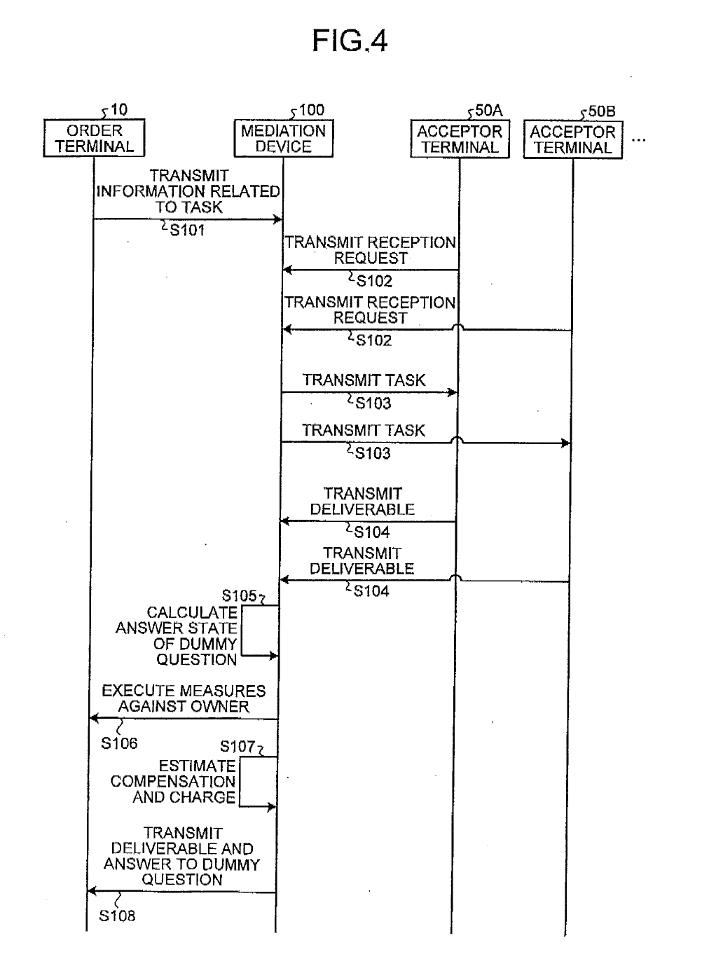

Next, a procedure of processing by the mediation device 100 according to an embodiment will be described with reference to FIG. 4. FIG. 4 is a sequence illustrating a mediation processing procedure by the mediation device 100 according to an embodiment.

As illustrated in FIG. 4, the order terminal 10 transmits information related to a task to the mediation device 100 (step S101). The mediation device 100 receives the information related to the task from the order terminal 10. Accordingly, the mediation device 100 registers the received task.

The acceptor terminal 50A transmits an acceptance request of the task to the mediation device 100 (step S102). Similarly, the acceptor terminal 50B and the acceptor terminal 50 transmit acceptance requests of the task to the mediation device 100. The mediation device 100 then receives the acceptance request of the task from the acceptor terminal 50. Accordingly, the mediation device 100 receives an application for the task from the acceptor terminal 50.

The mediation device 100 then transmits the task to the acceptor terminal 50 that is a transmission source of the acceptance request (step S103). Accordingly, the acceptor terminal 50 receives the task transmitted from the mediation device 100. Following that, the agent creates a deliverable of the task. The acceptor terminal 50 transmits the deliverable created by the agent to the mediation device 100 (step S104).

The mediation device 100 then receives the deliverable from the acceptor terminal 50. Following that, the mediation device 100 calculates the answer state of the dummy question included in the deliverable (step S105). For example, the mediation device 100 calculates the incorrect answer rate of the dummy question as the answer state of the dummy question for each dummy question.

The mediation device 100 then executes predetermined measures for the owner according to the calculated answer state (step S106). For example, the mediation device 100 stops display of the task including the dummy question, and transmits the notification to prompt the owner to change the dummy question, according to the incorrect answer rate of the dummy question.

Further, the mediation device 100 estimates the compensation to be paid to the agent and the charge to be billed to the owner according to the answer state of the dummy question (step S107). Further, the mediation device 100 transmits the deliverable and the answer to the dummy question to the order terminal 10 according to the answer state of the dummy question (step S108). For example, when the answer to the dummy question is a correct answer, the mediation device 100 transmits the deliverable including the answer to the dummy question to the order terminal 10. Meanwhile, when the answer to the dummy question is an incorrect answer, the mediation device 100 transmits only the answer to the dummy question of the deliverable to the order terminal 10. Accordingly, the mediation device 100 delivers the deliverable and the answer to the dummy question to the owner.

Note that the order of processing of steps S106 to S108 is not limited to the above-described processing order of step S106, step S107, and step S108, and may be executed in any order.

4. Modification

The mediation device 100 according to the embodiment may be implemented in various different embodiments other than the above-described embodiment. Hereinafter, another embodiment of the mediation device 100 will be described.

4-1. Pilot Study

While, in the above embodiment, an example of executing the predetermined measures for the owner according to the answer state of the dummy question has been exemplarily described, the mediation device 100 may determine employment/unemployment of a dummy question as pre-stage processing in advance.

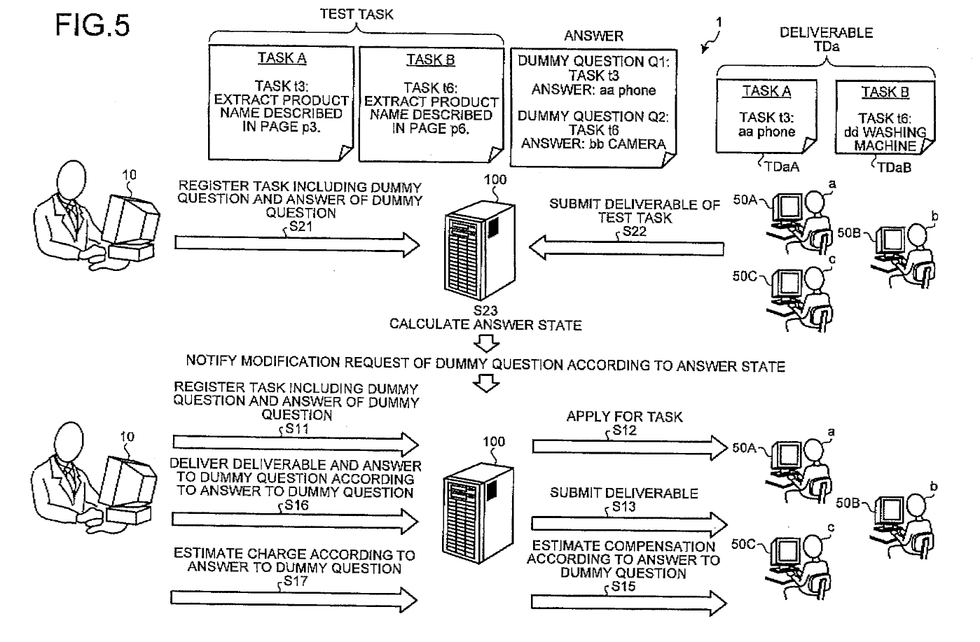

FIG. 5 is an explanatory diagram illustrating an example of mediation processing by a mediation device according to a modification. As illustrated in FIG. 5, a mediation device 100 receives a test task formed only of a dummy question and an answer of the dummy question from an order terminal 10. Accordingly, the mediation device 100 registers the test task and the answer of the dummy question to a task information storage unit 121 (step S21).

Following that, the mediation device 100 transmits the test task to acceptor terminals 50A to SOC. The acceptor terminals 50A to 50C then receive the test task transmitted from the mediation device 100. Here, an agent a creates a deliverable TDa of the test task received by the acceptor terminal 50A. Similarly, agents b to c create deliverables of the test task. The agent a operates the acceptor terminal 50A to transmit the deliverable TDa of the test task to the mediation device 100. Similarly, the agents b to c operate the acceptor terminals 50B to 50C to transmit the deliverables of the test task to the mediation device 100. Accordingly, the agents submit the deliverables of the test task to the owner (step S22).

Following that, the mediation device 100 grades the dummy question of the deliverable of the test task submitted from each agent. Accordingly, the mediation device 100 calculates the answer state of the dummy question (step 323). Here, the mediation device 100 notifies the owner of a modification request of the dummy question when ratio of incorrect answer for the dummy question included in the deliverables submitted from the agents is a predetermined threshold or more. Accordingly, the mediation device 100 can cause the owner to create a real task that is a modification of the dummy question having the incorrect answer rate of the predetermined threshold or more.

Meanwhile, when the incorrect answer rate of the dummy question is less than the predetermined threshold, the mediation device 100 employs the dummy question as the dummy question to be used in the real task. Accordingly, the mediation device 100 selects only a dummy question having certain level or more quality as the dummy question to be used in the real task.

Following that, the mediation device 100 similarly executes the above-described processing of steps S11 to S17. Note that, when the incorrect answer rate of the dummy question is the predetermined threshold or more, the task registered to the mediation device 100 in step S11 is a task including the dummy question modified by the owner. Further, in step S16, when the answer to the dummy question is an incorrect answer, the mediation device 100 may deliver not only the answer to the dummy question but also the deliverable to the owner. This is because the dummy question having the incorrect answer rate of the predetermined threshold or more has been removed in step S22, and thus the dummy question to be used in the real task is a dummy question having certain level or more quality, and there is no fault for the owner side.

As described above, the mediation device 100 determines employment/unemployment of a dummy question in advance. Therefore, a dummy question having certain level or more quality can be used in the real task. Accordingly, the mediation device 100 can evaluate the quality of the deliverable created by the agent with high accuracy.

4-2. Adjustment of Compensation by Reward

While, in the above embodiment, an example of estimating compensation to be paid to the agent according to the answer state of the dummy question has been exemplarily described, the mediation device 100 can adjust and estimate an amount of the compensation by a reward.

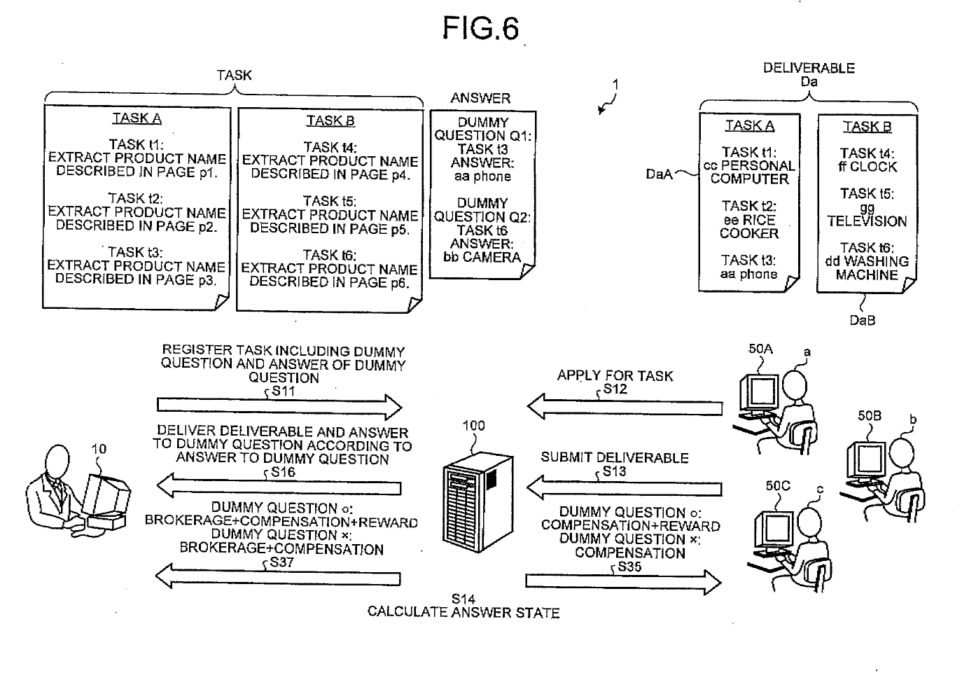

FIG. 6 is an explanatory diagram illustrating an example of mediation processing by a mediation device according to a modification. As illustrated in FIG. 6, when a dummy question has a correct answer, a mediation device 100 estimates a total amount by adding a reward to compensation that is a guaranteed minimum amount to an agent set in advance as compensation to be paid to the agent (step S35). Meanwhile, when the dummy question has an incorrect answer, the mediation device 100 estimates only the compensation without adding the reward as the compensation to be paid to the agent. Accordingly, the agent can receive the compensation that is, the minimum amount set in advance even if the agent has made the incorrect answer to the dummy question. Therefore, the mediation device 100 can guarantee the compensation to the agent.

Further, as illustrated in FIG. 6, when the dummy question has a correct answer, the mediation device 100 estimates a total amount of brokerage, compensation, and a reward as a charge to be billed to the owner (step S37). Meanwhile, when the dummy question has an incorrect answer, the mediation device 100 estimates a total amount of the brokerage and the compensation without adding the reward as the charge to be billed to the owner. Accordingly, the mediation device 100 can provide the owner with an incentive to create a high-quality dummy question.

As described above, the mediation device 100 allocates the compensation to be paid to the agent regardless of the correctness/incorrectness of the dummy question, and thus can guarantee the compensation to the agent. Accordingly, the mediation device 100 can improve motivation of the agent.

4-3. Interest of Intermediary (1)

While, in the above embodiment, an example of estimating the compensation to be paid to the agent and the charge to be billed to the owner according to the answer state of the dummy question has been exemplarily described, the mediation device 100 can secure the interest of the intermediary by adjusting the compensation and the charged amount according to the incorrect answer rate of the dummy question.

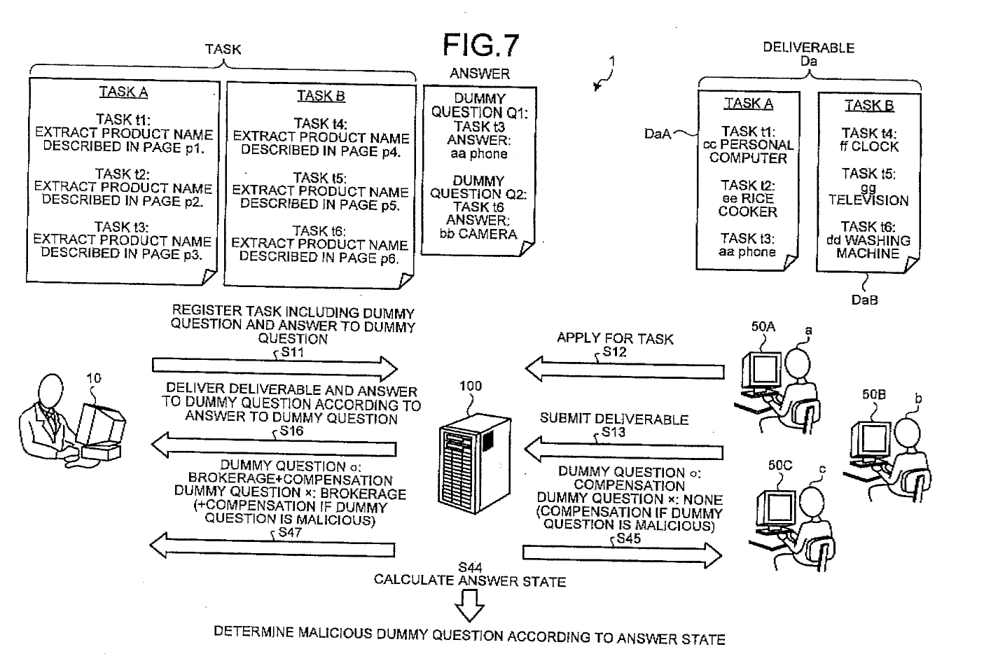

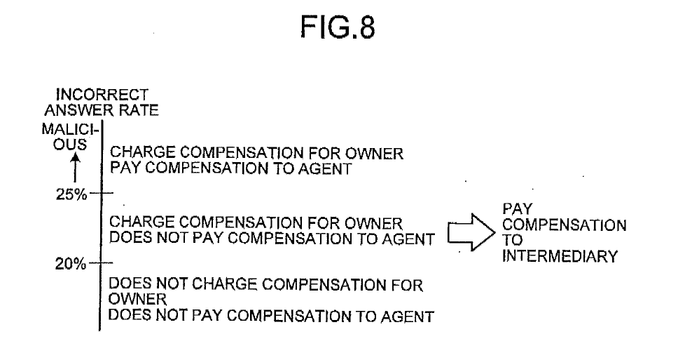

FIG. 7 is an explanatory diagram illustrating an example of mediation processing by a mediation device according to a modification. As illustrated in FIG. 7, a mediation device 100 determines a malicious dummy question according to some answer state of a dummy question (step S44). FIG. 8 is an explanatory diagram illustrating an example of processing according to an incorrect answer rate according to the modification. As illustrated in FIG. 8, when the incorrect answer rate of the dummy question is 25% or more, for example, the mediation device 100 determines the dummy is a malicious dummy question.

Further, when the dummy question has a correct answer, the mediation device 100 estimates compensation to be paid to an agent (step S45). Meanwhile, when the dummy question has an incorrect answer, the mediation device 100 estimates that the compensation to be paid to the agent is 0. In this case, the mediation device 100 does not charge the owner for the compensation. Further, the mediation device 100 does not pay the compensation to the agent. Note that, when the dummy question is determined to be malicious even if the dummy question has an incorrect answer, the mediation device 100 estimates the compensation to be paid to the agent. This is because the interest of the agent is protected when the dummy question is malicious. In this case, as illustrated in FIG. 8, the mediation device 100 charges the compensation for the owner. Further, the mediation device 100 pays the compensation to the agent. As described above, the example of FIG. 8 is different from the example of FIG. 1 in that, when the dummy question is malicious, the mediation device 100 estimates the compensation to be paid to the agent even if the dummy question has an incorrect answer.

Further, when the dummy question has a correct answer, the mediation device 100 estimates a total amount of brokerage and the compensation as a charge to be billed to the owner (step S47). Meanwhile, when the dummy question has an incorrect answer, the mediation device 100 estimates the brokerage as the charge to be billed to the owner. Note that, when the dummy question has been determined to be malicious even if the dummy question has an incorrect answer, the mediation device 100 estimates a total amount of the brokerage, and compensation for the deliverable that is to be paid to the intermediary instead of to the agent as the charge to be billed to the owner. This is because an incentive is provided to the owner to create a high-quality dummy question. Note that, as illustrated in FIG. 8, when an incorrect answer rate is from 20% to 25% (exclusive of 25%), the mediation device 100 charges the compensation for the owner. Further, the mediation device 100 pays the compensation to the intermediary instead of paying the compensation to the agent. This is because the compensation is collected as a penalty to the owner who has created the low-quality dummy question although it is not malicious.

As described above, when the incorrect answer rate is within a predetermined range, the mediation device 100 charges the owner for the compensation to be paid to the intermediary, and thus can cause the owner to create a high-quality dummy question. Accordingly, the mediation device 100 can protect the interest of the agent from the malicious dummy question.

4-4. Interest of Intermediary (2)

While, in the above-described embodiment, an example of delivering the deliverable according to the answer state of the dummy question has been exemplarily described, the mediation device 100 may deliver the deliverable regardless of the answer state of the dummy question.

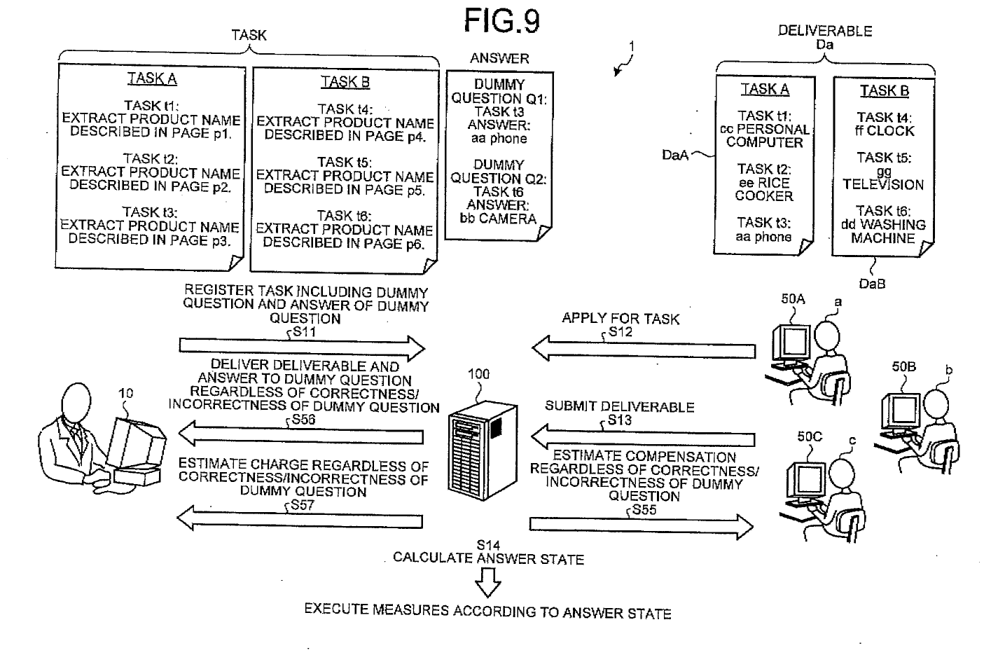

FIG. 9 is an explanatory diagram illustrating an example of mediation processing by a mediation device according to a modification. As illustrated in FIG. 9, a mediation device 100 calculates compensation to be received by an agent or an intermediary regardless of correctness/incorrectness of a dummy question (step S55). For example, when the dummy question has a correct answer, the mediation device 100 estimates the compensation to be paid to the agent. Meanwhile, when the dummy question has an incorrect answer, the mediation device 100 estimates the compensation to be received by the intermediary. As described above, the example of FIG. 9 is different from the example of FIG. 1 in that the mediation device 100 estimates the compensation to be received by the intermediary even if the dummy question has an incorrect answer.

Further, the mediation device 100 transmits a deliverable regardless of correctness/incorrectness of the dummy question (step S56). Further, the mediation device 100 estimates a total amount of brokerage and the compensation as a charge to be billed to the owner regardless of correctness/incorrectness of the dummy question (step S57).

As described above, the mediation device 100 transmits the deliverable, and charges the owner for the total amount of the brokerage and the compensation regardless of the correctness/incorrectness of the dummy question. Therefore, a simple transaction for the owner can be realized. Accordingly, the mediation device 100 can realize an appealing outsourcing form for the owner and the agents.

4-5. Payment by Points

While, in the above-described embodiment, an example of calculating the compensation according to the answer state of the dummy question has been exemplarily described, the mediation device 100 may estimate a point amount that can be used in an online shopping site or an auction site as the compensation. For example, a mediation device 100 estimates a point amount according to some answer state of a dummy question as compensation for a deliverable. Then, the mediation device 100 transmits the point to an acceptor terminal 50 that is a submission source of the deliverable. Accordingly, the mediation device 100 may pay the compensation to the agent.

4-6 Type of Task

While, in the above-described embodiment, a task to extract the information described on a web page specified by the owner has been exemplarily described, the mediation device 100 may be applied to various tasks. For example, a mediation device 100 may be applied to various types of work, such as translation of a document described in a foreign language, creation of an image, and creation of a program.

4-7. Type of Dummy Question

While, in the above-described embodiment, a descriptive dummy question has been exemplarily described, as illustrated in FIG. 1, the mediation device 100 may be applied to not only descriptive questions, but also questions in various types of formats. For example, an owner may register a multiple-choice question, in which a plurality of choices including a correct answer is prepared in advance, to a mediation device 100 as the dummy question.

4-8. Restriction of Agent

While, in the above-described embodiment, an example of outsourcing a task to the agents who has applied for the task has been exemplarily illustrated, the mediation device 100 may restrict the agents to which the task is to be outsourced according to a predetermined condition. For example, a mediation device 100 receives an application only from an agent whose various performances satisfy a condition, such as the number of tasks that has been treated by the agent in the past, or the quality of the deliverable. The mediation device 100 then transmits the task to the acceptor terminal 50 operated by the agent who satisfies the predetermined condition and has applied for the task. Accordingly, the mediation device 100 can outsource the task to the agent desired by the owner.

4-9. Measures for Acceptor

While, in the above-described embodiment, an example of executing the predetermined measures for the orderer has been exemplarily described, the mediation device 100 may execute the predetermined measures for the acceptor. For example, a mediation device 100 rejects an application from an agent who has made incorrect answers predetermined number of times or more to a dummy question having an incorrect answer rate less than a predetermined threshold. In another example, the mediation device 100 degrades evaluation of an agent who has made incorrect answers a predetermined number of times or more to the dummy question having the incorrect answer rate less than a predetermined threshold. Accordingly, the mediation device 100 can prevent the application from the agent who tends to create a low-quality deliverable.

4-10. Answer State of Dummy Question

While, in the above-described embodiment, an example of calculating the incorrect answer rate as the answer state of a dummy question has been exemplarily described, the mediation device 100 may calculate a correct answer rate as the answer state of a dummy question. The mediation device 100 then may execute predetermined measures according to the correct answer rate of the dummy question.

Further, the mediation device 100 may calculate an incorrect answer rate using only answers that satisfy a predetermined condition as the answer state of the dummy question. For example, the mediation device 100 calculates, as the answer state of the dummy question, the incorrect answer rate using only answers of a dummy question in which a time required for an agent to answer the question is a predetermined time or more. This is because there is a possibility that the agent answered the dummy question without reading it if the time required is less than a predetermined time. Therefore, such an answer is removed from the object.

In another example, the mediation device 100 calculates the incorrect answer rate as the answer state of the dummy question using only the answers of the dummy question by different agents. This is because the incorrect answer rate calculated from the answers of the dummy question by the same agent lacks reliability. Note that the mediation device 100 determines whether the agents are the same by determining whether IPs of transmission sources of deliverables are the same.

Further, in another example, the mediation device 100 calculates the incorrect answer rate as the answer state of the dummy question using only the answers to the dummy question of the agents whose deliverables have been delivered several times or more in the past. This is because the answer to the dummy question of the agents whose deliverables have been delivered several times or more in the past has high reliability. Further, in another example, the mediation device 100 calculates the incorrect answer rate using only the answers including a predetermined number of characters or more where the dummy question is a descriptive question. This is because, regarding the answer to the dummy question including less than a predetermined number of characters, there is a possibility that the agent answered the dummy question without considering the content of the question.

Further, in the above-described embodiment, the mediation device 100 may employ not only the dummy question including one question, but also a dummy question formed of a plurality of questions. For example, in a dummy question formed of two questions, inquiring, first, whether a transaction object is classified into either a product or a service, and next, whether the transaction object is durable consumer goods when the transaction object is a product, the mediation device 100 considers the answer to the questions is a correct answer only when both questions are correctly answered, and calculates the incorrect answer rate. Note that the mediation device 100 may calculate the incorrect answer rate in consideration of partial scores when only the classification question of the transaction object is correctly answered and the durable consumer goods question is incorrectly answered.

Further, the dummy question may be a question that is evaluated by the agent in five grades of “1 to 5”. In this case, when the agent has performed evaluation of “1” and “2” out of “1 to 5”, the mediation device 100 considers the evaluation as an incorrect answer and calculates the incorrect answer rate.

5. Others

Among the pieces of processing described in the embodiment, a part or all of the processing described as being automatically performed can be manually performed, and a part or all of the processing described as being manually performed can be automatically performed by a known method. In addition, the processing procedures, the specific names, the information including various data and parameters illustrated in the documents and drawings can be arbitrarily changed unless otherwise specified.

The illustrated configuration elements of the devices are a sort of function concepts, and are not necessarily physically configured like the illustration. That is, specific embodiments of distribution/integration of the devices are not limited to the illustration, and a part or all of the devices can functionally or physically be distributed/integrated in any units according to various loads and usages.

For example, the task information storage unit 121 illustrated in FIG. 2 may be held in a storage server, or the like without being held by the mediation device 100. In this case, the mediation device 100 acquires the information related to a task by accessing the storage server.

Further, the mediation device 100 may be a calculation device that performs only calculation processing by the calculation unit 133 without performing estimation processing. In this case, the calculation device does not include at least the measures unit 135, the estimation unit 136, and the delivery unit 137. A handling device including the measures unit 135 executes the predetermined measures for the owner. Further, an estimation device including the estimation unit 136 estimates the compensation to be paid to the agent and the charge to be billed to the owner. Further, a delivery device including the delivery unit 137 transmits the deliverable to the owner and the answer to the dummy question according to the answer state calculated by the calculation device.

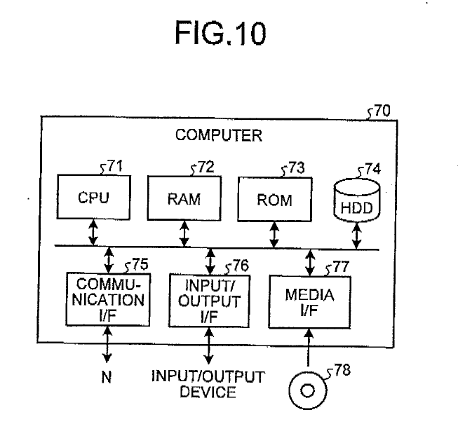

Note that the mediation device 100 in the embodiment is realized by a computer 70 having a configuration illustrated in FIG. 10. FIG. 10 is a hardware configuration diagram illustrating an example of the computer 70 that realizes the function of the mediation device 100. The computer 70 includes a CPU 71, a RAM 72, a read only memory(ROM) 73, a hard disk drive (HDD) 74, a communication interface (I/F) 75, an input/output interface (I/F) 76, and a media interface (I/F) 77.

The CPU 71 operates based on programs stored in the ROM 73 or the HDD 74, and controls each unit. The ROM 73 stores a boot program executed by the CPU 71 at the start-up of the computer 70, a program depending on hardware of the computer 70, and the like.

The HDD 74 stores a program executed by the CPU 71, data used by the program, and the like. The communication interface 75 receives data from another device through a network N and transmits the data to the CPU 71, and transmits data generated by the CPU 71 to another device through the network N.

The CPU 71 controls output devices such as a display and printer, and input devices such as a keyboard and a mouse through an input/output interface 76. The CPU 71 acquires data from the input devices through the input/output interface 76. Further, the CPU 71 outputs generated data to the output devices through the input/output interface 76.

The media interface 77 reads out programs or data stored in the recording medium 78, and provides the programs or data to the CPU 71 through the RAM 72. The CPU 71 loads the programs from the recording medium 78 to the RAM 72 through the media interface 77, and executes the loaded programs. The recording medium 78 is, for example, an optical record medium such as a digital versatile disc (DVD), a phase change rewritable disk (PD), a magneto-optical recording medium such as a magneto-optical disk (MO), a tape medium, a magnetic recording medium, or a semiconductor memory.

When the computer 70 functions as the mediation device 100 in the embodiment, the CPU 71 of the computer 70 realizes the functions of the task reception unit 131, the deliverable reception unit 132, the calculation unit 133, and the measures unit 135 by executing the programs loaded on the RAM 72. Further, data in the task information storage unit 121 is stored in the HDD 74.

While the CPU 71 of the computer 70 reads out the programs from the recording medium 78 and executes the programs, the CPU 71 of the computer 70 may acquire the programs from another device through the network N, as another example.

6. Effects

As described above, the mediation device 100 according to the embodiment includes the task reception unit 131 (corresponding to an example of a first reception unit), the deliverable reception unit 132 (corresponding to an example of a second reception unit), the calculation unit 133, and the measures unit 135. The task reception unit 131 receives a task (corresponding to an example of work) including one or more dummy questions from an order terminal used by an orderer. The deliverable reception unit 132 receives deliverables of the task including answers to the dummy question from a plurality of acceptor terminals used by a plurality of acceptors. The calculation unit 133 calculates some answer state of the dummy question included in the deliverables received by the deliverable reception unit 132. The measures unit 135 executes predetermined measures for the orderer according to the answer state calculated by the calculation unit 133.

Accordingly, the mediation device 100 according to the embodiment can cause the owner to create a high-quality dummy question. Further, the mediation device 100 can protect the interests of the owner and the agents, and thus can provide an appealing outsourcing form for the owner and the agents.

Further, in the mediation device 100 according to the embodiment, the calculation unit 133 calculates ratio of incorrect answer to the dummy question as the answer state. When the incorrect answer rate calculated by the calculation unit 133 is the predetermined threshold or more, the measures unit 135 executes at least one of measures to stop display of the task or measures to transmit notification to prompt change of the dummy question to the order terminal 10 as the predetermined measures for the orderer.

Accordingly, the mediation device 100 according to the embodiment can cause the owner to create a high-quality dummy question. Further, the mediation device 100 can maintain the quality of the dummy question at a certain level.

Further, in the mediation device 100 according to the embodiment, the deliverable reception unit 132 receives only the answers to the dummy question. The calculation unit 133 calculates ratio of incorrect answer to the dummy question received by the deliverable reception unit 132. When the incorrect answer rate calculated by the calculation unit 133 is the predetermined threshold or more, the measures unit 135 notifies the orderer of the modification request of the dummy question, as the predetermined measures for the orderer. The task reception unit 131 receives the task including the modified dummy question from the order terminal 10.

Accordingly, the mediation device 100 according to the embodiment determines employment/unemployment of the dummy question in advance, and thus can employ only the dummy question having certain level or more quality. Further, the mediation device 100 can evaluate the quality of the deliverables created by the agents with high accuracy.

Further, in the mediation device 100 according to the embodiment, the delivery unit 137 transmits any deliverable of the deliverables to the order terminal 10 according to the answer to the dummy question. The estimation unit 136 estimates the charge to be billed to the orderer according to the answer to the dummy question.

Accordingly, the mediation device 100 according to the embodiment can cause the owner to create a high-quality dummy question.

Further, in the mediation device 100 according to the embodiment, the delivery unit 137 transmits the deliverable to the order terminal 10 when the answer to the dummy question is a correct answer, and transmits only the answer to the dummy question of the deliverable to the order terminal 10 when the answer to the dummy question is an incorrect answer. The estimation unit 136 estimates the compensation to be received by the acceptor by including the compensation to the charge when the answer to the dummy question is a correct answer, and estimates the compensation without including the compensation to the charge when the answer to the dummy question is an incorrect answer.

Accordingly, the mediation device 100 according to the embodiment can cause the owner to create a high-quality dummy question, and can cause the agents to create high-quality deliverables. Further, the mediation device 100 can cause the intermediary to recognize the amount of the charge to be billed to the owner and the compensation to be paid to the agents.

Further, in the mediation device 100 according to the embodiment, the estimation unit 136 estimates, as the charge, the total amount of the compensation to be received by the acceptor as the guaranteed minimum amount and the reward for making the correct answer to the dummy question when the answer to the dummy question is a correct answer. Further, the estimation unit 136 estimates, as the charge, the compensation without adding the reward when the answer to the dummy question is an incorrect answer.

Accordingly, the mediation device 100 according to the embodiment can guarantee the minimum compensation to the agents. Further, the mediation device 100 can improve the motivation of the agents.

Further, in the mediation device 100 according to the embodiment, the calculation unit 133 calculates ratio of incorrect answer to the dummy question as the answer state. The estimation unit 136 estimates, as the charge, the compensation for the deliverables to be paid to the intermediary who manages the mediation device instead of to the acceptor, when the incorrect answer rate is the predetermined threshold or more, and the answer to the dummy question is an incorrect answer.

Accordingly, the mediation device 100 according to the embodiment can cause the owner to create a high-quality dummy question. Further, the mediation device 100 can secure the interest of the intermediary.

Further, in the mediation device 100 according to the embodiment, the delivery unit 137 transmits the deliverable to the order terminal 10 regardless of correctness/incorrectness of the answer to the dummy question. The estimation unit 136 estimates, as the charge, the compensation to be received by the acceptor when the answer to the dummy question is a correct answer, and estimates, as the charge, the compensation to be received by the intermediary who manages the mediation device when the answer to the dummy question is an incorrect answer.

Accordingly, the mediation device 100 according to the embodiment can realize a simple transaction for the owner. Further, the mediation device 100 can realize an appealing outsourcing form for the owner and the agents.

While some embodiments of the present application have been described based on the drawings, these embodiments are mere examples, and the present invention can be implemented in other forms, to which various modifications and improvements are applied based on knowledge of a person skilled in the art, including the aspects described in the disclosure of the invention.

Further, the mediation device 100 may be realized by a plurality of server computers, or can be realized by calling an external platform with an application programming interface (API) or network computing, depending on the functions. The configuration can be flexibly changed.

Further, “unit” described in the claims can be read as “section”, “module”, “unit”, “circuit”, or the like. For example, a reception unit can be read as a reception unit or a reception circuit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mediation device comprising:
a first reception unit configured to receive work including one or more dummy questions from an order terminal used by an orderer;
a second reception unit configured to receive deliverables of the work including answers to the dummy question from a plurality of acceptor terminals used by a plurality of acceptors;
a calculation unit configured to calculate some answer state of the dummy question included in the deliverables received by the second reception unit; and
a measures unit configured to execute predetermined measures according to the answer state calculated by the calculation unit.

2. The mediation device according to claim 1, wherein
the calculation unit
calculates ratio of incorrect answer to the dummy question as the answer state, and
the measures unit
executes at least one of measures to stop display of the work or measures to transmit notification to prompt change of the dummy question to the order terminal as the predetermined measures for the orderer when the incorrect answer rate calculated by the calculation unit is a predetermined threshold or more.

3. The mediation device according to claim 1, wherein
the second reception unit
receives only answers to the dummy question,
the calculation unit
calculates ratio of incorrect answer to the dummy question received by the second reception unit,
the measures unit
notifies the orderer of a modification request of the dummy question as the predetermined measures for the orderer when the incorrect answer rate calculated by the calculation unit is a predetermined threshold or more, and
the first reception unit
receives work including a modified dummy question from the order terminal.

4. The mediation device according to claim 1, further comprising:
a delivery unit configured to transmit any deliverable of the deliverables to the order terminal according to the answer to the dummy question; and
an estimation unit configured to estimate a charge to be billed to the orderer according to the answer to the dummy question.

5. The mediation device according to claim 4, wherein
the delivery unit
transmits the deliverable to the order terminal when the answer to the dummy question is a correct answer, and transmits only the answer to the dummy question of the deliverable when the answer to the dummy question is an incorrect answer, and
the estimation unit
estimates compensation to be received by the acceptor by including the compensation to the charge when the answer to the dummy question is a correct answer, and estimates the compensation without including the compensation in the charge when the answer to the dummy question is an incorrect answer.

6. The mediation device according to claim 4, wherein
the estimation unit
estimates, as the charge, a total amount of compensation to be received by the acceptor as a guaranteed minimum amount and a reward for making a correct answer to the dummy question when the answer to the dummy question is a correct answer, and estimates, as the charge, the compensation without adding the reward when the answer to the dummy question is an incorrect answer.

7. The mediation device according to claim 4, wherein
the calculation unit
calculates ratio of incorrect answer to the dummy question as the answer state, and
the estimation unit
estimates, as the charge, compensation for the deliverable to be paid to an intermediary who manages the mediation device instead of to the acceptor when the incorrect answer rate is a predetermined threshold or more, and the answer to the dummy question is an incorrect answer.

8. The mediation device according to claim 4, wherein
the delivery unit
transmits the deliverable to the order terminal regardless of correctness/incorrectness of the answer to the dummy question, and
the estimation unit
estimates compensation to be received by the acceptor as the charge when the answer to the dummy question is a correct answer, and estimates compensation to be received by an intermediary who manages the mediation device as the charge when the answer to the dummy question is an incorrect answer.

9. A mediation method executed by a mediation device, the method comprising:
receiving work including one or more dummy questions from an order terminal used by an orderer;
receiving deliverables of the work including answers to the dummy question from a plurality of acceptor terminals used by a plurality of acceptors;
calculating some answer state of the dummy question included in the deliverables; and
executing predetermined measures for the orderer according to the answer state.

10. A non-transitory recording medium on which a mediation program is recorded, the recording medium being executed by a computer and comprising:
receiving work including one or more dummy questions from an order terminal used by an orderer;
receiving deliverables of the work including answers to the dummy question from a plurality of acceptor terminals used by a plurality of acceptors;
calculating some answer state of the dummy question included in the deliverables; and
executing predetermined measures for the orderer according to the answer state.
